(19) United States
(12) Patent Application Publication
(10) Pub. No.: US 2025/0148064 A1
(43) Pub. Date: May 8, 2025

(54) Method and Device for Dynamic Access Control

(71) Applicant: Robert Bosch GmbH, Stuttgart (DE)

(72) Inventors: Jiawei Chen, Shanghai (CN); Jian Xu, Shanghai (CN); Li Zhang, Shanghai (CN)

(21) Appl. No.: 18/931,809

(22) Filed: Oct. 30, 2024

(30) Foreign Application Priority Data
Nov. 6, 2023 (CN) 2023 1146 0868.5

(51) Int. Cl. G06F 21/31

(52) U.S. Cl. CPC G06F 21/31

(57) ABSTRACT

A method for dynamic access control includes receiving a query request associated with a specific person within an organization and a target access object for which access control is to be performed. The method also includes utilizing an access control knowledge map for inferences based on the query request, and returning a query result according to the inferences. The query result indicates an access permission of the specific person for the target access object.

This application claims priority under 35 U.S.C. § 119 to patent application no. CN 2023 1146 0868.5, filed on Nov. 6, 2023 in China, the disclosure of which is incorporated herein by reference in its entirety.

The disclosure generally relates to the field of computers, and more particularly relates to a method and device for dynamic access control.

### BACKGROUND

At present, how to ensure data security of digital assets owned by organizations (e.g., enterprises, social groups, project teams, etc.) has become a major concern. Access control is a technique that is commonly used to ensure data security, which can make the digital assets of the organizations not freely accessible to anyone and allow only users with access permissions to access the digital assets by assigning corresponding access permissions to the users. Information about the access permission assignment may be stored statically in data structures such as tables, lists, etc.; and by querying in such data structures, whether a certain user is authorized to access a particular digital asset is determined.

However, as the computer technology develops and information becomes more popular, organizations typically have a large number of digital assets. In such cases, especially for organizations with large members, the manner of implementing access control by statically storing access permission assignment information in data structures such as tables typically involves heavy manual manipulation and may result in inefficient and inaccurate return of access permission query results. As a result, there is a need of an improved dynamic access control method, in order to improve efficiency and accuracy of access control for organizations.

### SUMMARY

It is desirable to provide an improved method for dynamic access control. A knowledge map can be constructed to dynamically maintain information associated with access control within an organization. An application used to provide access objects can query situations of an access permission owned by a specific person within the organization to a target access object through the knowledge map and control access of the specific person to the target access object based on a query result. Therefore, efficient and accurate dynamic access control may be implemented.

According to one aspect of the disclosure, a method for dynamic access control is provided, comprising: receiving a query request associated with a specific person within an organization and a target access object for which access control is to be performed; utilizing an access control knowledge map for inferences based on the query request; and returning a query result according to the inferences, wherein the query result indicates an access permission of the specific person for the target access object.

According to another aspect of the disclosure, a method for dynamic access control is provided, comprising: sending a query request associated with a specific person within an organization and a target access object for which access control is to be performed; receiving a query result, wherein the query result is obtained by inferences utilizing an access control knowledge map based on the query request, and the query result indicates an access permission of the specific person to the target access object; and controlling, based on the query result, access of the specific person to the target access object.

According to yet another aspect of the disclosure, a device for dynamic access control is provided, comprising: a memory; and a processor. The processor is coupled with the memory and is configured to perform the method according to any one of various examples of the disclosure.

According to yet another aspect of the disclosure, a non-transitory computer-readable medium is provided, a computer program comprising instructions is stored in the computer-readable medium, and the instructions, when executed by the processor, cause the processor to perform the method according to any one of various examples of the disclosure.

### BRIEF DESCRIPTION OF THE DRAWINGS

Various examples of the subject matter claimed are described by way of examples with reference to the accompanying drawings. The same reference numbers are used in different accompanying drawings to denote same or similar components.

FIG. 1 shows a schematic diagram of a structure of a system for dynamic access control according to one example of the disclosure.

FIG. 2 shows a schematic diagram of a structure of an access control knowledge map according to one example of the disclosure.

FIGS. 3A, 3B, 3C, and 3D show schematic diagrams of four inheritance modes according to one example of the disclosure.

FIG. 4A shows a flow chart of a method for dynamic access control according to one example of the disclosure.

FIG. 4B shows a flow chart of a method for dynamic access control according to one example of the disclosure.

FIG. 5 shows a block graph of a computing device that may implement the above-described method for dynamic access control according to one example of the disclosure.

### DETAILED DESCRIPTION

In the following description, numerous specific details are set forth to provide a thorough understanding of the examples of the disclosure. However, those skilled in the relevant art will recognize that the disclosure can be practiced without one or more specific details, or the disclosure can be practiced by using alternative methods, components, etc. In some examples, well-known structures and operations are not shown or described in detail to avoid unnecessarily obscuring the disclosure.

As discussed above in the section of Background Art, organizations typically require access control over digital assets they own in order to provide data protection for such digital assets. Organizations as discussed herein may refer to enterprises, social groups, project teams, and any other type of organization consisting of a group of members. Further, the digital assets described above may be referred to herein as access objects, which may comprise, for example, files, programs, services, applications, licenses, and any other tangible or intangible data information that requires access control.

Access control can be done by assigning respective access permissions to members of the organizations. Through permission assignment, only members who are assigned access permissions are allowed to access digital assets. It has been noted that a current manner to implement access control by assigning respective access permissions to each organization's member and statically maintaining access permission assignment information in data structures such as tables is inefficient and may result in the inability to provide accurate access query results. In response, an improved mechanism for dynamic access control is provided herein to solve at least the above problems.

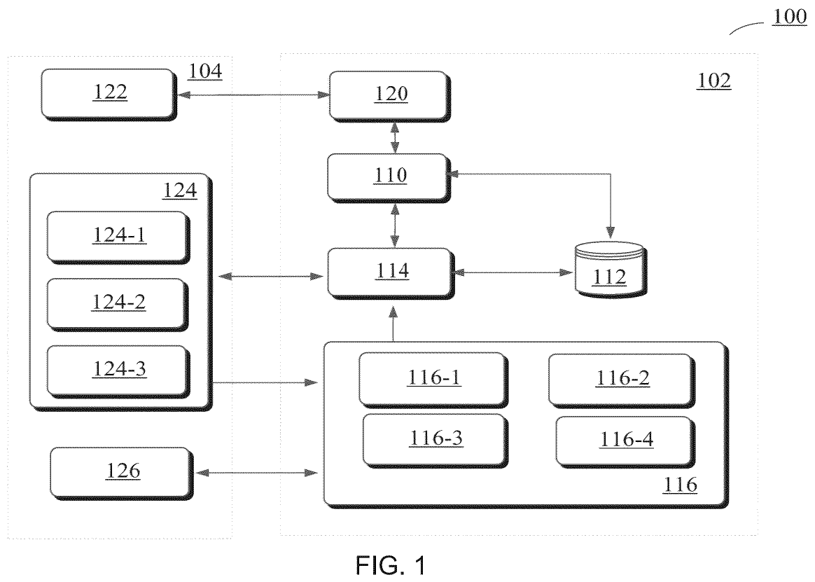

FIG. 1 shows a schematic diagram of a structure of a system 100 for dynamic access control according to one example of the disclosure. In one example, the system 100 may be used as a personnel access control or management platform for an organization (e.g., an enterprise). As shown in FIG. 1, the system 100 may comprise an access control sub-system 102 and an external support sub-system 104. Among them, the access control sub-system 102 may be used to implement core functions of dynamic access control discussed herein, while the external support sub-system 104 may be used to provide various external data, service support, etc. to the access control sub-system 102.

The access control sub-system 102 comprises an inference engine module 110 that may receive a query request, and the query request may be associated with a specific person within the organization and the target access object for which access control is to be performed. The inference engine module 110 may generate one or more graph query statements applicable to an access control knowledge map based on the received query request, so as to utilize the access control knowledge map to infer whether the specific person has an access permission to the target access object and what type of access permission the specific person has. The graph query statements may be based on SPARQL, Cipher, and any other graph query language known or otherwise known in the art. By way of example, the graph query statements may comprise MATCH statements, RETURN statements, etc. based on Cipher language. Depending on different user needs (in other words, different query targets), the inference engine module 110 can obtain the desired query result by modifying the graph query statements (e.g., adjusting parameter values in the graph query statements).

The above query request may be generated by an application module 120 in the access control sub-system 102. The application module 120 may be used to provide an access object for which access control is to be performed within an organization. In other words, members of the organization may perform access operations on the access object through the application module 120. For example, members may view browser pages, edit or view files, access storage space, etc. through the application module 120. In one application scenario, the application module 120 may generate a query request for a specific person and a target access object when the specific person attempts to perform an access operation on the object access object through the application module 120. In one example, the query request may be generated based on identification information of the specific person and the target access object. The identification information of the target access object may comprise, for example, a name, an identification number and an address of the target access object, or any other variety of information that may be used within the organization to uniquely identify the target access object. The identification information for the specific person may be any information such as the name, username, nickname, user ID, etc. used to uniquely identify that specific person within the organization. In one example aspect, the identification information of the specific person may be authenticated to ensure the legitimacy and authenticity of the identity of the specific person. Such authentication may be accomplished by an authentication module 122 in the external support sub-system 104. In this instance, the application module 120 may provide the authentication module 122 with the identification information of the specific person and receive authenticated identity information of the specific person from the authentication module 122 by way of information interaction between the application module 120 and the authentication module 122. The application module 120 may further generate a query request for the specific person based on the identity information.

The application module 120 may send the generated query request to the inference engine module 110. The inference engine module 110 may utilize the access control knowledge map for inferences to obtain a query result based on the query request and may further return the query result to the application module 120. Among them, the returned query result may indicate the access permission of the specific person to the target access object. The application module 120 may further control the access operation of the specific person to the target access object based on the query result. For example, if the query result indicates that the specific person has a read permission to the target access object, the application module 120 may allow the specific person to read the target access object; if the query result indicates that the specific person has a write permission to the target access object, the application module 120 may allow the specific person to perform a write operation on the target access object, and the like.

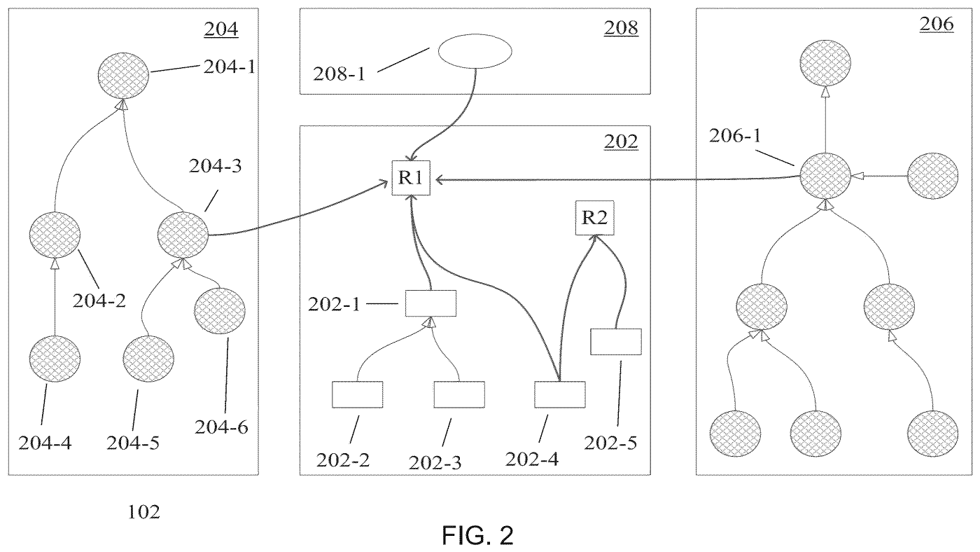

The access control knowledge map may be stored in a database 112 and may be called by the inference engine module 110 to perform the inferences with respect to access permissions. As those skilled in the art may appreciate, a knowledge map may be constructed based on entities and the relationships; and the entities may be expressed as nodes in the knowledge map, and the relationships may be expressed as edges connected between two nodes in the knowledge map. The access control knowledge map discussed herein may be constructed by the map construction module 114. The access control knowledge map may be constructed by the map construction module 114 as comprising a plurality of access object nodes and a plurality of organization nodes. Each access object node may correspond to one access object entity, and each organization node may correspond to one organization entity. Two organization nodes may be connected through an edge, and one organization node and one access object node may be connected through an edge, so that the organization affiliation relationship between the two organization entities and the access permission relationship of one organization entity to one access object entity can be represented respectively. In one example aspect, the two access object nodes can also be connected through an edge to represent an object affiliation relationship between the two access object entities. In the disclosure, although the relationships between two entities are schematically described, for example, an organization affiliation relationship between two organization entities, an access permission relationship of one organization entity to one access object entity, and an object affiliation relationship between two object entities, it should be understood that the two entities represent only a pair of interrelated entities in the constructed access control knowledge map. In fact, the access control knowledge map may be constructed based on relationships between multiple pairs of entities. In another example aspect, rule nodes may be set between the organization nodes and the access object nodes, rather than direct connection through the edges as discussed above. The rule nodes are used to describe the access permission relationship of the organization entities to the access object entities. In another example aspect, the access control knowledge map may also comprise role nodes corresponding to role entities. The content of the example structure for the access control knowledge map will be described in further detail below with reference to FIG. 2.

The above-described entities (comprising access object entities, organization entities, and optional role entities) and relationships (comprising the organization affiliation relationship and the access permission relationship, and optionally the object affiliation relationship) may be defined by an entity and relationship definition module 116.

An access object definition sub-module 116-1 in the entity and relationship definition module 116 may be used to define access object entities that correspond to multiple access objects (e.g., any file, program, service, application, license, etc.) requiring access control. At the same time, the access object definition sub-module 116-1 may also define the object affiliation relationship. For example, a segment of program code may be part of software, and therefore, the access object entity corresponding to the segment of program code may be defined as affiliating to the access object entity corresponding to the software. Accordingly, in the access control knowledge map constructed by a map construction module 114, the access object node corresponding to the segment of program code may be considered as a sub-node of the access object node corresponding to the software. The hierarchical arrangement of the access object nodes can impliedly define the following criteria: the access permission relationship applied to a particular access object node is also applied to one-hierarchy or multi-hierarchy sub-nodes of that particular access object node, as described in further detail below with reference to FIG. 2.

An organization definition sub-module 116-2 in the entity and relationship definition module 116 may be used to define the organization entities. The organization entities may be defined based on a hierarchical architecture of the organization. Depending on the hierarchical architecture of the organization, all members of the organization can be divided into various sub-organizations belonging to different hierarchies. In one example aspect, the hierarchical architecture of the organization can be divided according to people management. For example, a general manager may constitute a first hierarchy of sub-organization, a manager of the hardware development department and a manager of the software development department under the general manager may constitute a second hierarchy of sub-organizations, respectively, and a hardware development engineer under the manager of the hardware development department and a software development engineer 1 and software development engineer 2 under the manager of the software development department constitute a third hierarchy of sub-organizations, respectively. Based on the above-mentioned hierarchical architecture, the organization definition sub-module 116-2 may define organization entities corresponding to different hierarchies of sub-organizations. For example, the general manager may be defined as the first hierarchy of organization entity,
the manager of the hardware development department and the manager of the software development department are defined as the second hierarchy of organization entities, respectively, and the hardware development engineer and the software development engineer 1 and software engineer 2 are defined as the third hierarchy of organization entities, respectively. Such hierarchical relationship may be embodied in the access control knowledge map constructed by the map construction module 114 as organization nodes correspondingly arranged according to hierarchies. At the same time, the organization affiliation relationship between the two organization entities may be defined by the organization definition sub-module 116-2 based on the jurisdictional relationships described above. In another example aspect, the hierarchical architecture of the organization can be divided according to project management. Based on such division, the process of defining the organization entities and the organization affiliation relationship may be consistent with the above description for people management and will not be described in detail for brevity and clarity.

A rule definition sub-module 116-3 in the entity and relationship definition module 116 may be used to define an access permission relationship of the organization entities to the access object entities. It can be defined that the respective organization entity has or does not have access permissions to the respective access object entity. In one example aspect, a type of the access permission relationship may be further defined, for example, a read permission, a write permission, a management permission, etc. It can be defined that the respective organization entity has at least one of the various types of access permissions described above to the respective access object entity, e.g., at least one of a read permission, a write permission, a management permission, etc. Among them, the read permission may specify that the organization entity is authorized to view the content of the access object entity, the write permission may specify that the organization entity is authorized to edit the access object entity, and the management permission may specify that the organization entity is authorized to modify the type of the access permission relationship applied to the access object entity, for example, to modify the read permission to the write permission.

In situations where a resource description framework (\hat{ }\hat{ }) data model is utilized to describe various knowledge in the access control knowledge map, an attribute field may be utilized to describe the type of the access permission relationship. As discussed above, based on the access permission relationship defined by the rule definition sub-module 116-3, the map construction module 114 may accordingly establish edges or rule nodes connected between the organization nodes and the access object nodes in the access control knowledge map.

The entity and relationship definition module 116 also comprises an optional role definition sub-module 116-4, which may be used to define the role entities. The role entities can describe such information: What type of role permission a certain member in the organization has to the above-mentioned access permission relationship. The type of role permissions may comprise an administrator role that may modify the access permission relationship of the organization entity to the access object entity. In one example aspect, modification of the access permission relationship requires approval from the administrator. To this end, the external support sub-system 104 may further comprise an approval module 126 for implementing the above-described approval process. Role types can also comprise role viewing, role editing, etc., wherein only the access permission relationship can be viewed through the role viewing, and the access permission relationship can be edited through role editing (such editing operations may require approval from the administrator to take effect). In the access control knowledge map, the role nodes corresponding to the role entities may be connected to the rule nodes, and the edges between the role nodes and the rule nodes may describe whether the role entities have respective role permissions to the access permission relationship specified by the rule nodes.

Based on the above-described entities and relationships defined by the entity and relationship definition module 116, for example, the access control knowledge map constructed by the access object entities and the object affiliation relationship, the organization entities and the organization affiliation relationship, the access permission relationship of the organization entities to the access object entities, and the role entities and role permissions, may dynamically maintain information associated with permission assignment to members within the organization. For example, the permission assignment information maintained by the access control knowledge map may be dynamically adjusted by updating the relationships described above, thereby enabling dynamic access control of a specific person. As such, a dynamic access control mechanism of the disclosure is more flexible and efficient than statically maintaining the access permission for each member in the prior art, for example, requiring manual adjustment of the access permission assigned to each member to enable adjustment of access permissions.

A user may utilize the entity and relationship definition module 116 to directly implement the above-described process of defining the entities and the relationships. In addition, the entity and relationship definition module 116 may also extract such entities and relationships from the existing external source data. In one example aspect, the extraction of the entities and the relationships from the existing external source data can be accomplished by extracting, converting, loading (ETL) operations. As illustrated in FIG. 1, the entity and relationship definition module 116 may extract such entities and relationships from external source data provided by a source data providing module 124 in the external support sub-system 104. The source data providing module 124 may further comprise a personnel management sub-module 124-1, a project management sub-module 124-2, and a role management sub-module 124-3 to interact with respective external source databases to provide organization hierarchical architecture information associated with personnel management, organization hierarchical architecture information associated with project management, and personnel role information. Among them, the personnel role information may be maintained in an access control list (ACL) as known in the art. Within the ACL, respective roles can be defined for the members of the organization. The entities and relationships defined or extracted by the entity and relationship definition module 116 through the above-described operations may be expressed as nodes and edges in the constructed access control knowledge map, respectively. In this instance, when the inference engine module 110 receives the query request, graph query statements may be generated to execute the query with the constructed access control knowledge map to obtain, for example, a query result of an access permission of a specific person to the target access object.

In one example aspect, the external source data described above may be stored in a non-graphic data structure, such as a table, a list, etc. In this instance, the map construction module 114 may construct the access control knowledge map to comprise virtual nodes and edges. In other words, the virtual nodes and edges do not directly describe the entities and the relationships themselves, but describe a mapping relationship between the entities and relationship and the external source data provided by the source data providing module 124. In this instance, when the inference engine module 110 receives the query request, the constructed access control knowledge map may be utilized, the query is executed based on the mapping relationship between the entities and relationships maintained by the access control knowledge map and the external source data to obtain, for example, the query result of the access permission of the specific person to the target access object. After the inference engine module 110 generates the graph query statements based on the query request, the map construction module 114 may further convert the graph query statements to query statements that are adapted to the data structure of the external source data, for example, table query statements like SQL. As such, corresponding table data may be further retrieved in the external source database based on the above-mentioned mapping relationship maintained in the access control knowledge map and the converted table query statements. The map construction module 114 may then convert the retrieved table data into graph data and generate the query result through the inference engine module 110 based on the converted graph data. The potential adverse effects caused by the latency of map data updates can be avoided by maintaining the above mapping relationship in the access control knowledge map compared to extracting the entities and relationships directly from the external source database. For example, information in the external source database has been updated (e.g., the organization affiliation relationship of the specific person has changed), while relevant knowledge in the access control knowledge map has not been updated in time, resulting in the inaccurate query result obtained with the access control knowledge map.

Various components (e.g., sub-systems, modules, sub-modules, etc.) in the example structure shown in FIG. 1 may be embodied as independently functioning applications, services, etc., and information interaction with each other may be achieved through application programming interfaces (APIs). Alternatively, these components can also be embodied as various functional modules in a complete application, service, etc., and can enable information interaction with each other through underlying data calling, etc. In such instances, the application or service, etc., may be used as a whole to implement a complete process discussed above of utilizing the access control knowledge map to query the access permission of the specific person to the target access object and control the access of the specific person to the target access object based on the query process. Further, it should be noted that the structure of the system 100 discussed above is merely exemplary. As may be contemplated by those skilled in the art, the system 100 may adopt different arrangements, e.g., comprise more or fewer modules, sub-modules than those shown, without departing from the scope of the disclosure.

FIG. 2 shows a schematic diagram of a structure of an access control knowledge map according to one example of the disclosure.

In FIG. 2, the access control knowledge map is divided into different portions to more clearly illustrate the example structure of the access control knowledge map. Among them, a graph structure associated with access objects and rules is shown in block 202, a graph structure associated with organization information based on personnel management is shown in block 204, a graph structure associated with organization information based on project management is shown in block 206, and a graph structure associated with role information is shown in block 208.

In block 204 and block 206, a plurality of organization nodes (represented by circles) arranged according to hierarchies are shown respectively. Six organization nodes 204-1 to 204-6 at three hierarchies are shown in block 204. In conjunction with the example described in detail above with reference to FIG. 1, the first hierarchy comprises an organization node 204-1 corresponding to the general manager. The second hierarchy comprises an organization node 204-2 corresponding to a manager of the hardware development department and an organization node 204-3 corresponding to a manager of the software development department. The third hierarchy comprises an organization node 204-4 corresponding to the hardware development engineer, an organization node 204-5 corresponding to the software development engineer 1 and an organization node 204-6 corresponding to the software development engineer 2. At the same time, an edge between two organization nodes (a connecting line with an arrow in block 204 of FIG. 2) indicates that two corresponding sub-organizations have an affiliation relationship. In such hierarchical arrangements, for a current organization node (e.g., 204-3), the organization node (e.g., 204-1) at the previous hierarchy that has a connection relationship with it may be referred to as a parent node of the current organization node, while the organization node (e.g., 204-5) at the next hierarchy that has a connection relationship with it may be referred to as a child node of the current organization node. In block 206, an example of constructed organization nodes arranged according to hierarchies and the edge connected between two organization nodes when the organization hierarchy structure is represented by project management is shown in a similar manner as in block 204, and is omitted here for brevity of the description. It is noted that although block 204 associated with personnel management and block 206 associated with project management are shown concurrently in FIG. 2, it should be understood that the access control knowledge map may also comprise only information associated with personnel management or only information associated with project management.

In block 202, a plurality of access object nodes (which are represented by rectangles and are marked 202-1 to 202-5) and a plurality of rule nodes (which are represented by squares and
are marked “R1” and “R2”) corresponding to the access permission relationship that the organization entity has to the access object entity. The rule nodes may specify types of access permissions, e.g., R1 may correspond to the management permission, and R2 may correspond to the read permission, etc. Each rule node may be connected between the organization node and the access object node. As shown in FIG. 2, the rule node R1 may be connected between the organization node 204-3 and the access object node 202-1, indicating that the organization entity corresponding to the organization node 204-3 has the management permission to the access object entity corresponding to the access object node 202-1. In addition, the plurality of organization nodes may be connected to the same rule node at the same time. For example, the rule node R1 is also connected between another organization node 206-1 and the access object node 202-1, which similarly indicates that the organizing entity corresponding to the organization node 206-1 has the management permission to the access object entity corresponding to the access object node 202-1.

Further, as shown in block 202 in FIG. 2, a plurality of access object nodes may be arranged in a decentralized manner such that two access object nodes are not connected through the edge, i.e., there is no relationship between the two corresponding access object entities, as shown by access object nodes 202-1, 202-4, and 202-5. Alternatively, the access object nodes may also be arranged according to hierarchies, for example, the access object node 202-2 and the access object node 202-3 are connected with the access object node 202-1 through edges, indicating that the access object node 202-2 and the access object node 202-3 are affiliated to the access object node 202-1. Such hierarchical arrangements may impliedly define that the access permission relationship (denoted by the rule node R1 as the management permission) applied to the access object node 202-1 is also applied to the one-hierarchy or multi-hierarchy (if there are more layers) sub-nodes of the access object node 202-1, for example, the access object node 202-2 and the access object node 202-3. In other words, based on the example structure of the access control knowledge map shown in FIG. 2, it can be inferred that the organization entity corresponding to the organization node 204-3 has the same management permission to access object entities corresponding to the access object node 202-2/the access object node 202-3.

The role node 208-1 is shown in block 208 of FIG. 2, which may correspond to a role entity (e.g., an administrator role) described above. The role node 208-1 may be connected to the rule node R1 through an edge. It is to be noted that in the event that the organization node 204-3 and the role node 208-1 are connected to the rule node R1 simultaneously as shown in FIG. 2, the connection between the organization node 204-3 and the rule node R1 and the connection between the role node 208-1 and the rule node R1 are consistent with the (AND) logical relationship. More specifically, based on the illustrated structure, it can be inferred that only a person belonging only to a sub-organization corresponding to the organization node 204-3 and having an administrator role at the same time can modify the access permission relationship specified by the rule node R1.

In one example aspect, it may be further defined that the connection relationship between the organization node and the rule node (represented as the edge between the two nodes) has different inheritance modes. The inheritance modes may be embodied in the access control knowledge map as an attribute of the edge.

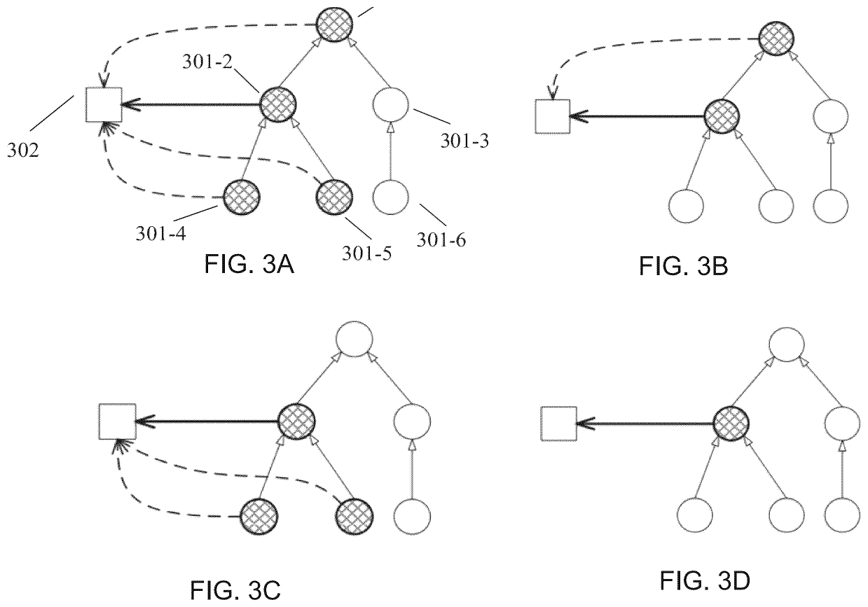

FIG. 3A to FIG. 3D show schematic diagrams of four example inheritance modes according to one example of the disclosure. In FIG. 3A to FIG. 3D, the organization nodes are represented with circles, and the rule nodes are represented with squares. It will be understood that FIG. 3A to FIG. 3D show only a portion of the complete access control knowledge map for convenience and that the complete access control knowledge map may comprise a plurality of rule nodes and a plurality of organization nodes.

The first inheritance mode is a two-way inheritance mode, as shown in FIG. 3A. FIG. 3A comprises six organization nodes 301-1 to 301-6 and one rule node 302, and the organization node 301-2 is connected to the rule node 302. For ease of description, the rule node 302 may be referred to as a first rule node, and the organization node 301-2 connected with the rule node 302 is referred to as a first organization node. It should be understood that the “first” rule node here is used only to differentiate one rule node from other rule nodes without any sequential definition. Similarly, the “first” organization node is only used to differentiate one organization node from other organization nodes without any sequential definition. Further, FIG. 3A shows the parent node 301-1 of the organization node 301-2 and the child nodes 301-4 and 301-5 of the organization node 301-2. The two-way inheritance mode indicates that the connection relationship between the first organization node and the first rule node is inherited by the parent node and the child node of the first organization node. In other words, based on the connection relationship between the organization node 301-2 and the rule node 302 and the connection relationship in the two-way inheritance mode, it may be inferred that the parent node 301-1 and child nodes 301-4 and 301-5 of the organization node 301-2 and the rule node 302 also implicitly have the connection relationship (as shown by edges indicated by the dashed lines in FIG. 3A).

The second inheritance mode is an upward inheritance mode which indicates that the connection relationship between the first organization node and the first rule node is inherited only by the parent node of the first organization node, as shown in FIG. 3B. In other words, based on the connection relationship between the first organization node and the first rule node and the connection relationship in the upward inheritance mode, it can be inferred that the parent node of the first organization node and the first rule node implicitly have the connection relationship (as shown in the edge indicated by the dashed line in FIG. 3B).

The third inheritance mode is a downward inheritance mode which indicates that the connection relationship between the first organization node and the first rule node is inherited only by the sub-node of the first organization node. In other words, based on the connection relationship between the first organization node and the first rule node and
the connection relationship in the downward inheritance mode, it can be inferred that the sub-node of the organization node and the rule node implicitly have the connection relationship (as shown in the edge indicated by the dashed line in FIG. 3C).

The fourth inheritance mode is a no-inheritance mode, which indicates that the connection relationship between the organization node and the rule node is not inherited by the parent node or the child node of the organization node. As shown in FIG. 3D, based on the connection relationship between the organization node and the rule node and the connection relationship in the no-inheritance mode, it cannot be inferred that the parent node and/or the child node of the organization node implicitly have the connection relationship.

Such inheritance modes may more efficiently describe instances of the access permissions of the organization entities to the access object entities. For example, the access permissions of only higher-hierarchy organization entities or less organization entities rather than each organization member to the access object may be maintained in the knowledge map.

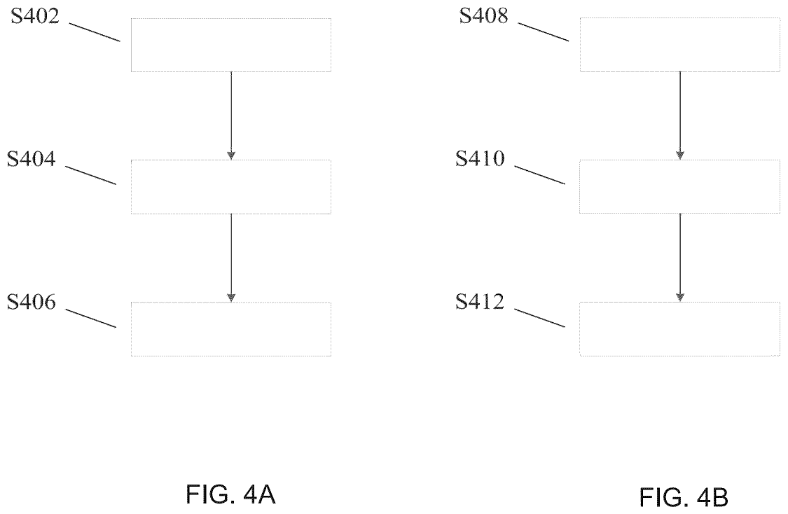

FIG. 4A and FIG. 4B show flow charts of a method for dynamic access control according to one example of the disclosure, respectively. Among them, FIG. 4A describes a process for querying an access permission of a specific person to a target access object utilizing an access control knowledge map, and thus can be referred to as an operation performed on a query side. FIG. 4B describes an operation for access control on a target access object according to a query result, and thus can be referred to as an operation performed on the access control side.

The content of the operation performed on the query side are described below in connection with FIG. 4A. In one example, the method steps shown in FIG. 4A may be performed by the inference engine module 110 as described above in connection with FIG. 1.

At step S402, a query request may be received. The query request may be associated with the specific person within the organization and the target access object for which access control is to be performed. As discussed in reference to FIG. 1, the above-mentioned query request may be generated by the application module 120 and transmitted to the inference engine module 110.

At step S404, inferences may be performed by utilizing the access control knowledge map based on the query request. The access control knowledge map may be constructed based on the plurality of entities and the relationship between two entities of the plurality of entities, wherein the plurality of entities may comprise a plurality of access object entities and a plurality of organization entities, a plurality of access object entities correspond to a plurality of access objects for which access control is to be performed, and the plurality of organization entities correspond to a plurality of sub-organizations of the organization divided into different hierarchies. The relationships may comprise an organization affiliation relationship between two of the plurality of organization entities and an access permission relationship between a respective organization entity of the plurality of organization entities and a respective access object entity of the plurality of access object entities. The plurality of entities may further comprise at least one role entity, such that the relationship may further comprise a respective role permission of a respective role entity to the access permission relationship. The relationship may also comprise an object affiliation relationship between two access object entities of the plurality of access object entities. As discussed in reference to FIG. 1, the above-described entities and relationships may be defined by the entity and relationship definition module 116 or extracted from external source data. In addition, based on the above-described entities and relationships, the access control knowledge map may be constructed by representing such entities and relationships into nodes and edges in the access control knowledge map through the map construction module 114.

At step S406, the query result may be returned according to inferences. The query result may indicate that the specific person has an access permission to the target access object. As discussed in reference to FIG. 1, a query result may be provided to the application module 120 by the inference engine module 110, such that the application module 120 may control access of the specific person to the target access object based on the query result.

The content of the operation performed on the access control side is described below in connection with FIG. 4B. In one example, the method steps shown in FIG. 4B may be performed by the application module 120 as described above in connection with FIG. 1.

At step S408, a query request may be sent. The query request may be associated with the specific person within the organization and the target access object for which access control is to be performed. As discussed in reference to FIG. 1, the above-mentioned query request may be generated by the application module 120 and transmitted to the inference engine module 110. In one example, the inference engine module 110 may perform step S402 discussed above in connection with FIG. 4A to receive the query request.

At step S410, a query result may be received. The query result may be obtained by inferences utilizing the access control knowledge map based on the query request, and may indicate the access permission of the specific person to the target access object. As discussed in reference to FIG. 1, the query result may be generated by the inference engine module 110 and returned to the application module 120. In one example, the query result may be obtained by performing step S404 discussed above with the FIG. 4A by the inference engine module 110.

At step S412, access of the specific person to the target access object may be controlled based on the query result. As discussed in reference to FIG. 1, access operations of the specific person to the target access object may be controlled by the application module 120 based on the query result. For example, if the query result indicates that the specific person has a read permission to the target access object, the application module 120 may allow the specific person to read the target access object; if the query result indicates that the specific person has a write permission to the target access object, the application module 120 may allow the specific person to perform a write operation on the target access object; and the like.

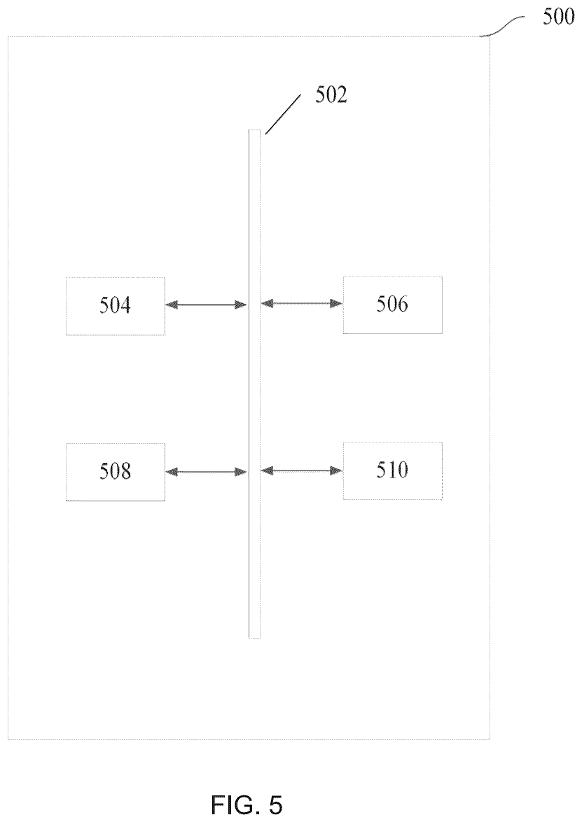

FIG. 5 shows a block diagram of a computing device that may implement the above-described method for dynamic access control according to one example of the disclosure.

The example computing device 500 comprises an internal communication bus 502 and a processor (e.g., a central processing unit (CPU)) 504 connected to the internal communication bus 502, the processor 504 being used for executing instructions stored in the memory 506 to implement the method for dynamic access control described in detail above. The memory 506 is suitable for physically embodying computer program instructions and data, and may comprise various forms of memory, for example, comprises semiconductor memory devices such as EPROM, EEPROM, and flash memory devices; magnetic disks such as internal hard disks and removable disks; magneto-optical disks; and CD-ROM disks, etc. The computing device 500 may also comprise an input/output (I/O) interface 508, such that various I/O devices (e.g., cursor control devices such as mice, keyboards, etc.) may be coupled to the computing device 500 through the I/O interface 508 to allow a user to apply various commands and input data. The computing device 500 may also comprise a display unit 510 for displaying a graphical user interface.

The computer program may comprise instructions executable by the computer, the instructions being used for causing the processor 504 of the computing device 500 to perform the method for dynamic access control of the disclosure. The program may be recorded on any data storage medium, including the memory. For example, the program may be implemented in digital electronic circuits or computer hardware, firmware, software, or a combination thereof. The process/method steps described in the disclosure can be performed by a programmable processor executing program instructions to perform operations on input data and generate output to perform the method, steps, and operations.

In addition to the content described in this document, various modifications can be made to the disclosed examples and implementations of the disclosure without departing from the scope of the disclosed examples and implementations of the disclosure. Therefore, the description and examples herein should be interpreted as illustrative and not restrictive. The scope of the disclosure should only be determined by reference to the claims.

What is claimed is:

1. A method for dynamic access control, comprising:
receiving a query request associated with a specific person within an organization and a target access object for which access control is to be performed;
utilizing an access control knowledge map for inferences based on the query request; and
returning a query result according to the inferences,
wherein the query result indicates an access permission of the specific person for the target access object.

2. The method according to claim 1, wherein:
the access control knowledge map is constructed based on a plurality of entities and a relationship between two entities of the plurality of entities,
the plurality of entities comprises a plurality of access object entities and a plurality of organization entities, the plurality of access object entities corresponds to a plurality of access objects for which access control is to be performed, the plurality of access objects comprises the target access object, and the plurality of organization entities corresponds to a plurality of sub-organizations of the organization divided into different levels, and
the relationship comprises:
an organization affiliation relationship between two organization entities of the plurality of organization entities, and
an access permission relationship between a respective organization entity of the plurality of organization entities and a respective access entity of the plurality of access object entities.

3. The method according to claim 2, wherein:
the plurality of entities further comprises at least one role entity; and
the relationship further comprises at least one of (i) a respective role permission of a respective role entity of the at least one role entity for the access permission relationship, and (ii) an object affiliation relationship between two access object entities of the plurality of access object entities.

4. The method according to claim 3, wherein:
the access control knowledge map comprises a plurality of access object nodes corresponding to the plurality of access object entities, a plurality of organization nodes corresponding to the plurality of organization entities, and at least one role node corresponding to the at least one role entity; and
in the access control knowledge map (i) the organization affiliation relationship is represented as an edge connected between two organization nodes corresponding to the two organization entities; the access permission relationship is represented as a rule node connected between an organization node corresponding to the respective organization entity and an access object node corresponding to a respective access object entity, (ii) the object affiliation relationship is represented as an edge connected between two access object nodes corresponding to the two access object entities, and (iii) the respective role permission is represented as an edge connected between a role node corresponding to the respective role entity and a rule node corresponding to the access permission relationship.

5. The method according to claim 4, wherein:
the rule node in the access control knowledge map further specifies a type of the access permission relationship; and
the type of the access permission relationship comprises at least one of a management permission, a read permission, and a write permission.

6. The method according to claim 4, wherein:
the query result is derived based on an inheritance mode of a connection relationship between a first organization node of the plurality of organization nodes and a first rule node of a plurality of rule nodes; and
the inheritance mode comprises one of (i) a two-way inheritance mode, which indicates that a connection relationship between the first organization node and the first rule node is inherited by a parent node and a child node of the first organization node, (ii) an upward inheritance mode, which indicates that the connection relationship between the first organization node and the first rule node is inherited solely by the parent node of the first organization node, (iii) a downward inheritance mode, which indicates that the connection relationship between the first organization node and the first rule node is inherited solely by the child node of the first organization node, and (iv) a no-inheritance mode, which indicates that the connection relationship between the first organization node and the first rule node is not inherited by the parent node or the child node of the first organization node.

7. The method according to claim 1, wherein utilizing the access control knowledge map for inferences based on the query request comprises:
generating, based on the query request, one or more graph query statements applicable to the access control knowledge map; and
inferring, based on the one or more graph query statements, the access permission of the specific person to the target access object.

8. The method according to claim 7, wherein:
a plurality of entities and relationships for constructing the access control knowledge map are extracted from external source data; and
the access control knowledge map comprises virtual nodes and edges, and the virtual nodes and edges describe a mapping relationship between the plurality of entities and relationship and the external source data.

9. The method according to claim 8, wherein utilizing the access control knowledge map for inferences based on the query request further comprises converting the one or more graph query statements into converted table query statements applicable to a data structure of the external source data; and retrieving, based on the converted table query statements, corresponding table data in the external source data.

10. The method according to claim 1, further comprising:
controlling, based on the query result, access of the specific person to the target access object.

11. A method for dynamic access control, comprising:
sending a query request associated with a specific person within an organization and a target access object for which access control is to be performed;
receiving a query result by inferences utilizing an access control knowledge map based on the query request, the query result indicating an access permission of the specific person to the target access object; and
controlling, based on the query result, access of the specific person to the target access object.

12. The method according to claim 11, wherein the method is for an access control side, and the query result is obtained at a query side by the inferences using the access control knowledge map based on the query request.

13. The method according to claim 11, wherein:
the access control knowledge map is constructed based on a plurality of entities and a relationship between two of the plurality of entities,
the plurality of entities comprises a plurality of access object entities and a plurality of organization entities, the plurality of access object entities corresponds to a plurality of access objects for which access control is to be performed, the plurality of access objects comprises the target access object, and the plurality of organization entities corresponds to a plurality of sub-organizations of the organization divided into different levels, and
the relationship comprises (i) an organization affiliation relationship between two organization entities of the plurality of organization entities, and (ii) an access permission relationship between a respective organization entity of the plurality of organization entities and a respective access entity of the plurality of access object entities.

14. The method according to claim 13, wherein:
the plurality of entities further comprises at least one role entity; and
the relationship further comprises at least one of (i) a respective role permission of a respective role entity of the at least one role entity for the access permission relationship, and (ii) an object affiliation relationship between two access object entities of the plurality of access object entities.

15. The method according to claim 14, wherein:
the access control knowledge map comprises a plurality of access object nodes corresponding to the plurality of access object entities, a plurality of organization nodes corresponding to the plurality of organization entities, and at least one role node corresponding to the at least one role entity; and
in the access control knowledge map (i) the organization affiliation relationship is represented as an edge connected between two organization nodes corresponding to the two organization entities, (ii) the access permission relationship is represented as a rule node connected between an organization node corresponding to the respective organization entity and an access object node corresponding to a respective access object entity, (iii) the object affiliation relationship is represented as an edge connected between two access object nodes corresponding to the two access object entities, and (iv) the respective role permission is represented as an edge connected between a role node corresponding to the respective role entity and a rule node corresponding to the access permission relationship.

16. The method according to claim 15, wherein:
the rule node in the access control knowledge map further specifies a type of the access permission relationship; and
the type of the access permission relationship comprises at least one of a management permission, a read permission, and a write permission.

17. The method according to claim 16, wherein:
the query result is derived based on an inheritance mode of a connection relationship between a first organization node of the plurality of organization nodes and a first rule node of a plurality of rule nodes; and
the inheritance mode comprises one of (i) a two-way inheritance mode, which indicates that a connection relationship between the first organization node and the first rule node is inherited by a parent node and a child node of the first organization node, (ii) an upward inheritance mode, which indicates that the connection relationship between the first organization node and the first rule node is inherited solely by the parent node of the first organization node, (iii) a downward inheritance mode, which indicates that the connection relationship between the first organization node and the first rule node is inherited solely by the child node of the first organization node, and (iv) a no-inheritance mode, which indicates that the connection relationship between the first organization node and the first rule node is not inherited by the parent node or the child node of the first organization node.

18. The method according to claim 11, wherein:
a plurality of entities and relationships for constructing the access control knowledge map are extracted from external source data; and
the access control knowledge map comprises virtual nodes and edges, and the virtual nodes and edges describe a mapping relationship between the plurality of entities and relationship and the external source data.

19. A device for dynamic access control, comprising:
a memory; and
a processor coupled with the memory, the processor configured to perform the method according to claim 1.

20. A non-transitory computer-readable medium storing a computer program comprising instructions, the instructions, when executed by a processor, cause the processor to be configured to perform the method according to claim 1.
